(19) United States
(12) Patent Application Publication
(10) Pub. No.: US 2025/0329790 A1
(43) Pub. Date: Oct. 23, 2025

(54) STACKED ELECTRODE ASSEMBLY AND POWER STORAGE MODULE

(71) Applicant: TOYOTA JIDOSHA KABUSHIKI KAISHA, Aichi-ken (JP)

(72) Inventors: Hajime HASEGAWA, Aichi-gun (JP); Yusuke IKEDA, Miyoshi-shi (JP); Tetsuya MIMURA, Chiryu-shi (JP); Tomofumi HIRUKAWA, Miyoshi-shi (JP); Shizuka MASUOKA, Nagoya-shi (JP); Hiroki AWANO, Susono-shi (JP); Kosuke YONEKAWA, Nisshin-shi (JP); Jun IZUMI, Toyota-shi (JP)

(21) Appl. No.: 19/172,651

(22) Filed: Apr. 8, 2025

(30) Foreign Application Priority Data
Apr. 18, 2024 (JP) 2024-067543

(51) Int. Cl. H01M 10/0585; H01M 4/13; H01M 10/052; H01M 50/474; H01M 50/486

(52) U.S. Cl. CPC H01M 10/0585; H01M 4/13; H01M 10/052; H01M 50/474; H01M 50/486

(57) ABSTRACT

A stacked electrode assembly extends in a second direction perpendicular to a first direction which is a laminate direction of each of the electrodes and each of the separators. First and second surfaces of a metallic foil of the electrode each have an active-material coated area and an active-material uncoated area extending in the second direction. The active-material uncoated area of the second surface is located on the back of the active-material uncoated area of the first surface. The active-material uncoated area of the second surface has a first resin placement area in which a resin is disposed and which is located on the active-material coated area side of the second surface. Spaces are formed between the separator and end portions, in a third direction perpendicular to the first and second directions and on the first resin placement area side, of the active-material uncoated area of the second surface.

### CROSS REFERENCE TO RELATED APPLICATIONS

This nonprovisional application is based on Japanese Patent Application No. 2024-067543 filed on Apr. 18, 2024 with the Japan Patent Office, the entire content of which is hereby incorporated by reference.

### BACKGROUND

### Field

The present disclosure relates to a stacked electrode assembly and a power storage module.

### Description of the Background Art

Conventionally, power storage modules are known. As such power storage modules, Japanese Patent Laying-Open No. 2022-65369 discloses a power storage device intended to reduce the time required for impregnation of an electrolyte solution. The power storage device includes a cell stack in which multiple power storage cells are stacked in a laminate direction. Each power storage cell includes a liquid injection tube providing a communication between inside and outside of the power storage cell. The liquid injection tube has: a liquid injection port passing through a spacer; a first inside path extending in an orientation along the short side as viewed in the laminate direction; and a second inside path extending from a short side to a short side of a positive active material layer as viewed in the laminate direction. A discharge hole facing the positive active material layer is formed in each of the first inside path and the second inside path.

The spacer is disposed between a positive current collector and a negative current collector and joined to the positive current collector and the negative current collector so as to enclose the positive active material layer and the negative active material layer as viewed in the laminate direction. Specifically, the spacer forms an accommodating space enclosed by the spacer, the positive current collector, and the negative current collector. The accommodating space accommodates the separator, the positive active material layer, and the negative active material layer being impregnated with the electrolyte solution. The spacer also functions as a seal sealing the accommodating space between the positive current collector and the negative current collector, preventing the electrolyte solution accommodated in the accommodating space from leaking out.

### SUMMARY

In the battery cell disclosed in Japanese Patent Laying-Open No. 2022-65369, the electrolyte solution, injected through the liquid injection port, selectively passes through the first inside path and the second inside path, and is discharged into the accommodating space through a respective discharge hole. In the battery cell, since the first inside path and the second inside path are formed within the accommodating space, spaces for installing the first inside path and the second inside path need to be secured within the accommodating space. Therefore, for the power storage module disclosed in Japanese Patent Laying-Open No. 2022-65369 that includes multiple number of such battery cells, reduction of the volumetric energy density is inevitable.

The present disclosure provides: a stacked electrode assembly that has excellent electrolyte solution impregnation property and inhibits the reduction of the volumetric energy density in the power storage module; and a power storage module that includes the stacked electrode assembly.

A stacked electrode assembly according to a certain aspect of the present disclosure includes: a plurality of electrodes; and a plurality of separators. Each of the electrodes and each of the separators are alternately stacked in a first direction. The stacked electrode assembly extends in a second direction perpendicular to the first direction. The electrode includes a metallic foil having a first surface and a second surface which is a backside of the first surface. The first surface and the second surface each have an active-material coated area extending in the second direction and coated with an active material and an active-material uncoated area continuing to the active-material coated area in the second direction and not coated with the active material. The active-material uncoated area of the second surface is located on back of the active-material uncoated area of the first surface of the metallic foil. The active-material uncoated area of the second surface has a first resin placement area in which a resin is disposed and which is located on an active-material coated area side of the second surface. A first space is formed between the separator and an end portion, in a third direction perpendicular to the first direction and the second direction and on a first resin placement area side, of the active-material uncoated area of the second surface.

With such a configuration, the electrolyte solution can be impregnated into the stacked electrode assembly through the first spaces. In other words, the first spaces can be used as supply passages for the electrolyte solution. Accordingly, this obviates the need for a conduit, for guiding the electrolyte solution, in the housing accommodating the stacked electrode assembly. Therefore, the stacked electrode assembly has excellent electrolyte solution impregnation property and inhibits the reduction of the volumetric energy density in the power storage module including the stacked electrode assembly and the housing.

Preferably, the resin is in contact with the separator. A length of the first resin placement area in the third direction is shorter than a length of the metallic foil in the third direction.

With such a configuration, the first spaces can be formed in the stacked electrode assembly.

Preferably, a resin spacer is disposed between the resin and the separator.

With such a configuration, the first spaces can be formed in the stacked electrode assembly.

Preferably, the active-material uncoated area of the first surface has a second resin placement area in which a resin is disposed and which is located on an active-material coated area side of the first surface. A second space is formed between the separator and an end portion, in the third direction and on a second resin placement area side, of the active-material uncoated area of the first surface.

With such a configuration, the electrolyte solution can be impregnated into the stacked electrode assembly through the first spaces and the second spaces. Therefore, electrolyte solution impregnation property is excellent, as compared to the case where only the first spaces of the first and second spaces are formed.

According to another aspect of the present disclosure, the power storage module includes the stacked electrode assembly and a housing accommodating the stacked electrode assembly.

With such a configuration, the stacked electrode assembly having excellent electrolyte solution impregnation property can be used to configure the power storage module. Therefore, the reduction of the volumetric energy density can be inhibited.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a power storage module.

FIG. 2 is a diagram showing a stacked electrode assembly included in the power storage module.

FIG. 3 is a diagram showing a negative electrode as viewed in a predetermined orientation.

FIG. 4 is a diagram showing the negative electrode as viewed in an orientation opposite that of FIG. 3.

FIG. 5 is a diagram showing the negative electrode as viewed in the orientation indicated by an arrow V of FIGS. 3 and 4.

FIG. 6 is a cross-sectional arrow view of the stacked electrode assembly taken along a VI-VI line of FIG. 2.

FIG. 7 is a diagram showing the stacked electrode assembly.

FIG. 8 is a diagram showing a negative electrode as viewed in a predetermined orientation.

FIG. 9 is a diagram showing the negative electrode as viewed in an opposite orientation to FIG. 8.

FIG. 10 is a diagram showing the negative electrode as viewed in the orientation indicated by an arrow X of FIGS. 8 and 9.

FIG. 11 is a cross-sectional arrow view of the stacked electrode assembly taken along an XI-XI line of FIG. 7.

### DESCRIPTION OF THE PREFERRED EMBODIMENTS

Hereinafter, an embodiment according to the present disclosure will be described, with reference to the accompanying drawings. Note that the embodiment below uses the same reference signs to refer to the same or common parts, and description thereof will not be repeated.

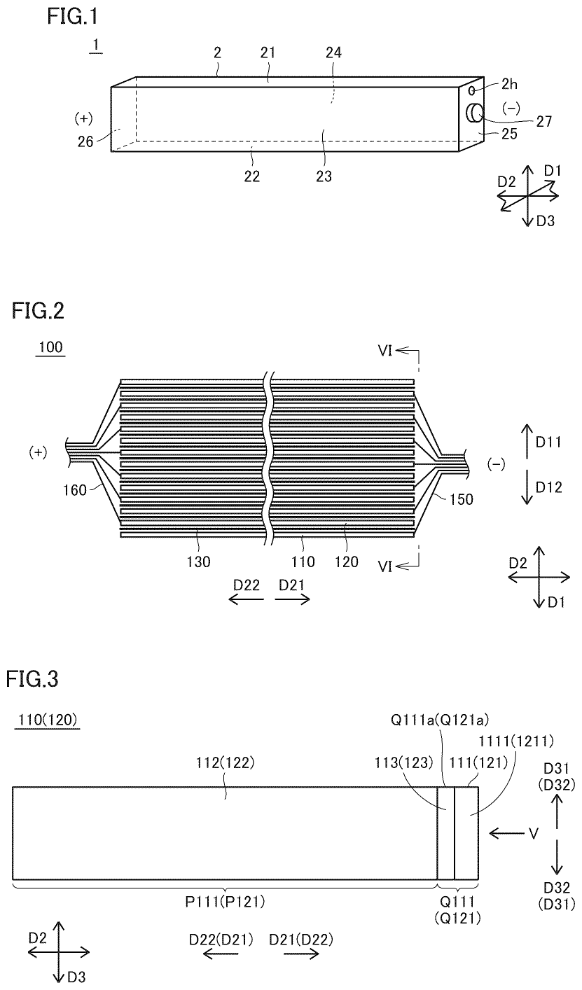

FIG. 1 is a perspective view of a power storage module according to the present embodiment. FIG. 2 is a diagram showing a stacked electrode assembly included in the power storage module of FIG. 1. As shown in FIGS. 1 and 2, a power storage module 1 has a blade shape. Power storage module 1 includes a stacked electrode assembly 100 and a housing 2 accommodating stacked electrode assembly 100. Note that, in the following, for convenience of illustration, power storage module 1 will be described, with reference to an example in which the power storage module 1 is oriented so that a D3 direction shown in FIGS. 1, 2, etc. is the vertical direction (more specifically, the orientation of D31 described below is vertically upward), except when an electrolyte solution is injected, which will be described below.

Power storage module 1 is, in this example, a lithium iron phosphate (LFP) battery. However, the present disclosure is not limited thereto. Power storage module 1 may be a nickel manganese cobalt (NMC) battery. Power storage module 1 is mounted on, for example, a battery electric vehicle traveling with a driving force obtained from electrical energy. Specifically, a battery pack, including multiple power storage modules 1 aligned in a predetermined direction, is mounted on a battery electric vehicle. The battery pack is mounted on the vehicle body of the battery electric vehicle. The battery pack constitutes a part of the vehicle body. The battery pack serves as the structure of the vehicle body.

As shown in FIG. 1, housing 2 has a generally cuboid shape. Housing 2, in this example, is made of metal. Housing 2 has first to sixth surfaces 21 to 26. A first surface 21, a second surface 22, a third surface 23, and a fourth surface 24 continue in the listed order. First surface 21, second surface 22, third surface 23, and fourth surface 24 constitute the outer circumferential surface of housing 2.

A fifth surface 25 and a sixth surface 26 are end surfaces of housing 2. First surface 21 is the top surface, second surface 22 is the bottom surface, and third surface 23 and fourth surface 24 are side surfaces. A negative-side external connection terminal 27 is disposed on fifth surface 25. A positive-side external connection terminal (not shown) is disposed on sixth surface 26.

As shown in FIG. 2, stacked electrode assembly 100 has multiple electrodes (a negative electrode 110, a positive electrode 120) and multiple separators 130. Stacked electrode assembly 100 includes multiple electrodes stacked in D1 direction (a laminate direction). Specifically, in stacked electrode assembly 100, a negative electrode 110 and a positive electrode 120 are alternately stacked in D1 direction with a separator 130 in-between. In order to prevent a short circuit from occurring between negative electrode 110 and positive electrode 120, the length of separator 130 in D3 direction is longer than the length of each of negative electrode 110 and positive electrode 120 in D3 direction. Note that the D1 direction is the width direction of power storage module 1.

Stacked electrode assembly 100 further includes tabs 150 connected to negative-side external connection terminal 27 and tabs 160 connected to the positive-side external connection terminal. Tab 150 is a collection of copper foils. Tab 160 is a collection of aluminum foils. Note that the orientation of D11 in D1 direction is the orientation from third surface 23 toward fourth surface 24 of housing 2 of FIG. 1. The orientation of D21 in D1 direction is the orientation from fourth surface 24 toward third surface 23.

As shown in 1, power storage module 1 and housing 2 extend in D2 direction. As shown in 2, stacked electrode assembly 100 extends in D2 direction. D2 direction is perpendicular to D1 direction. D2 direction is the longitudinal directions of power storage module 1, housing 2, and stacked electrode assembly 100. D3 direction is perpendicular to D1 direction and D2 direction. D3 direction is the height direction of power storage module 1. Note that the orientation of D21 in D2 direction is the orientation from sixth surface 26 to fifth surface 25 of housing 2 of FIG. 1. The orientation of D22 in D2 direction is the orientation from fifth surface 25 to sixth surface 26.

D1 direction is the lateral directions of first surface 21, second surface 22, fifth surface 25, and sixth surface 26. D2 direction is the longitudinal directions of first to fourth surfaces 21 to 24. D3 direction is the lateral directions of third and fourth surfaces 23 and 24 and the longitudinal directions of fifth and sixth surfaces 25 and 26. An injection hole 2h is formed in fifth surface 25 for injecting an electrolyte solution into housing 2. Injection hole 2h is formed closer to first surface 21 of housing 2 than second surface 22. Injection hole 2h is formed closer to first surface 21 than external connection terminal 27. Note that, in FIG. 1, since the electrolyte solution is already injected inside the housing 2, injection hole 2h is sealed. Injection hole 2h may be temporarily sealed by inserting a detachable stopper into injection hole 2h. Alternatively, injection hole 2h may be sealed with a resin or a metal so that no electrolyte solution can be injected into housing 2 again, unless the through-hole is opened.

When the electrolyte solution is injected into housing 2 through injection hole 2h, for example, during the manufacturing of power storage module 1, the orientation of power storage module 1 is kept so that D2 direction is substantially the vertical direction and fifth surface 25 is located above the sixth surface 26. Due to the self-weight of the electrolyte solution, the electrolyte solution flows from the fifth surface 25 side to the sixth surface 26 side. Note that the electrolyte solution, since it has a certain degree of viscosity, falls within housing 2 at a slow speed. This allow the electrolyte solution to be impregnated into stacked electrode assembly 100. Note that the method of injection of the electrolyte solution is not limited thereto. the electrolyte solution may be injected into power storage module 1 while the pressure inside the power storage module 1 is vacuumed (vacuum injection).

In this example, injection hole 2h is formed closer to first surface 21 than external connection terminal 27. However, the present disclosure is not limited thereto. Injection hole 2h may be formed closer to second surface 22 than external connection terminal 27. Injection hole 2h may be formed closer to third surface 23 than external connection terminal 27. Injection hole 2h may be formed closer to fourth surface 24 than external connection terminal 27.

Further in this example, injection hole 2h is formed in fifth surface 25. However, the present disclosure is not limited thereto. For example, injection hole 2h may be formed in sixth surface 26. Injection hole 2h may be formed in first surface 21 or second surface 22. When injection hole 2h is formed in first surface 21 or second surface 22, preferably, injection hole 2h is formed closer to the end side (the fifth surface 25 side or the sixth surface 26 side) of housing 2 in the longitudinal direction than the middle portion from the standpoint of liquid injection property. Injection hole 2h may be formed in third surface 23 or fourth surface 24. The location of formation of injection hole 2h is not particularly limited.

FIG. 3 is a diagram showing negative electrode 110 as viewed in the orientation of D11 of FIG. 2. Note that FIG. 3 shows the orientations and reference signs for parts of positive electrode 120 in parentheses for convenience of illustration to describe positive electrode 120 together.

As shown in FIG. 3, negative electrode 110 includes a metallic foil 111. Metallic foil 111 is a base member for negative electrode 110. Metallic foil 111 is, typically, a copper foil. Metallic foil 111 extends in D2 direction across the length of negative electrode 110 in D2 direction. Similarly, metallic foil 111 extends in D3 direction across the length (width) of negative electrode 110 in D3 direction. D1 direction is the direction of thickness of metallic foil 111.

Metallic foil 111 has a first primary surface 1111. First primary surface 1111 extends in D2 direction across the length of negative electrode 110 in D2 direction. Similarly, first primary surface 1111 extends in D3 direction across the length (width) of negative electrode 110 in D3 direction. The normal direction of first primary surface 1111 is D1 direction.

First primary surface 1111 has an active-material coated area P111 extending in D2 direction and coated with an active material 112. First primary surface 1111 further has an active-material uncoated area Q111 continuing to active-material coated area P111 in D2 direction and not coated with active material 112. Active-material uncoated area Q111 is positioned in the orientation of D21 relative to active-material coated area P111.

Active-material uncoated area Q111 has a partial area Q111a in which a resin 113 is disposed and which is located on the active-material coated area P111 side of first primary surface 1111. In this example, partial area Q111a continues to active-material coated area P111. In first primary surface 1111, only active-material uncoated area Q111, not including partial area Q111a, is exposed. Specifically, in FIG. 3, the right end portion of metallic foil 111 is exposed. Note that the orientation of D32 in D3 direction is the vertically downward orientation.

Note that the resin 113 can be formed by, for example, coating partial area Q111a with a resin. The present disclosure is not limited thereto. Resin 113 may be formed by a resin film being heat welded to partial area Q111a. The resin film may be welded by laser exposure, etc. Resin 113 is disposed in partial area Q111a by such an approach. Note that the same goes for resins 123, 115, 115A, 125, and 125A described below.

Next, positive electrode 120 is described. Positive electrode 120 includes a metallic foil 121. Metallic foil 121 is a base member for positive electrode 120. Metallic foil 121 is, typically, an aluminum foil. Metallic foil 121 extends in D2 direction across the length of positive electrode 120 in D2 direction. Similarly, metallic foil 121 extends in D3 direction across the length (width) of positive electrode 120 in D3 direction. D1 direction is the direction of thickness of metallic foil 121.

Metallic foil 121 has a first primary surface 1211. First primary surface 1211 extends in D2 direction across the length of positive electrode 120 in D2 direction. Similarly, first primary surface 1211 extends in D3 direction across the length (width) of positive electrode 120 in D3 direction. The normal direction of first primary surface 1211 is D1 direction. In this example, in the orientation of D11, first primary surface 1111 of negative electrode 110, a second primary surface 1112 of negative electrode 110, first primary surface 1211 of positive electrode 120, and a second primary surface 1212 of positive electrode 120 are repeatedly positioned in the listed order.

First primary surface 1211 has an active-material coated area P121 extending in D2 direction and coated with an active material 122. First primary surface 1211 further has an active-material uncoated area Q121 continuing to active-material coated area P121 in D2 direction and not coated with active material 122. Active-material uncoated area Q121 is positioned in the orientation of D22 relative to active-material coated area P121.

Active-material uncoated area Q121 has a partial area Q121a in which the resin 123 is disposed and which is located on the active-material coated area P121 side of first primary surface 1211. In this example, partial area Q121a continues to active-material coated area P121. In first primary surface 1211, only active-material uncoated area Q121, not including partial area Q121a, is exposed. In FIG. 3, the right end portion of metallic foil 121 is exposed. Note that, in this example, resin 123 includes the same material as resin 113.

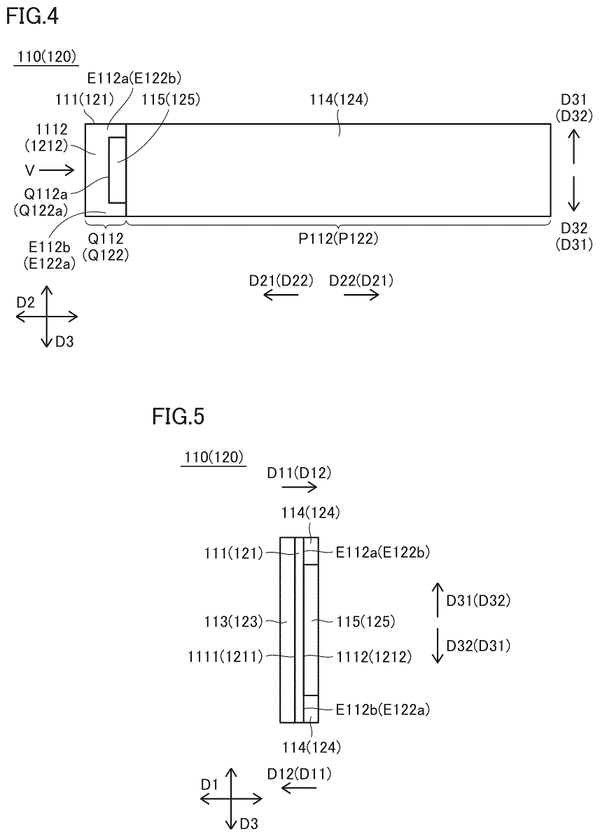

FIG. 4 is a diagram showing negative electrode 110 as viewed in the orientation of D12 of FIG. 2. Note that, as with FIG. 3, FIG. 4 shows the orientations and reference signs for parts of positive electrode 120 in parentheses to describe positive electrode 120 together.

As shown in FIG. 4, metallic foil 111 further has a second primary surface 1112. Second primary surface 1112 is the backside of first primary surface 1111 of FIG. 3. As with first primary surface 1111, second primary surface 1112 extends in D2 direction across the length of negative electrode 110 in D2 direction. Second primary surface 1112 extends in D3 direction across the length (width) of negative electrode 110 in D3 direction. The normal direction of second primary surface 1112 is the same as the normal direction (D1 direction) of first primary surface 1111.

Second primary surface 1112 has an active-material coated area P112 extending in D2 direction and coated with an active material 114. Second primary surface 1112 further has an active-material uncoated area Q112 continuing to active-material coated area P112 in D2 direction and not coated with active material 114. Active-material uncoated area Q112 is positioned in the orientation of D21 relative to active-material coated area P112.

Active-material uncoated area Q112 has a partial area Q112a in which the resin 115 is disposed and which is located on the active-material coated area P112 side of second primary surface 1112. In this example, partial area Q112a continues to active-material coated area P112. Resin 115 includes the same material as resin 113.

Active-material uncoated area Q112 further has a first end portion E112a and a second end portion E112b. Second end portion E112b is located below the first end portion E112a. Partial area Q112a does not reach first end portion E111a. Similarly, partial area Q112a does not reach second end portion E111b.

Thus, the length of partial area Q112a in D3 direction is shorter than the length of metallic foil 111 in D3 direction. The length of partial area Q112a in D3 direction is shorter than the length (width) of second primary surface 1112 in D3 direction. The length of partial area Q112a in D3 direction is shorter than the length of active-material uncoated area Q112 in D3 direction. The length of partial area Q112a in D3 direction is shorter than the length of partial area Q111a in D3 direction of FIG. 3.

In second primary surface 1112, only active-material uncoated area Q112, not including partial area Q112a, is exposed. Specifically, in second primary surface 1112, only the U-shaped area of active-material uncoated area Q112, not including partial area Q112a, is exposed. Specifically, in FIG. 4, the left end portion of metallic foil 111 and portions of metallic foil 111 above and below the partial area Q112a are exposed.

Next, positive electrode 120 is described. Metallic foil 121 of positive electrode 120 further has a second primary surface 1212. Second primary surface 1212 is the backside of first primary surface 1211 of FIG. 3. As with first primary surface 1211, second primary surface 1212 extends in D2 direction across the length of positive electrode 120 in D2 direction. Second primary surface 1212 extends in D3 direction across the length (width) of positive electrode 120 in D3 direction. The normal direction of second primary surface 1212 is the same as the normal direction (D1 direction) of first primary surface 1211.

Second primary surface 1212 has an active-material coated area P122 extending in D2 direction and coated with an active material 124. Second primary surface 1212 further has an active-material uncoated area Q122 continuing to active-material coated area P122 in D2 direction and not coated with active material 124. Active-material uncoated area Q122 is positioned in the orientation of D22 relative to active-material coated area P122.

Active-material uncoated area Q122 has a partial area Q122a in which the resin 125 is disposed and which is located on the active-material coated area P122 side of second primary surface 1212. In this example, partial area Q122a continues to active-material coated area P122. Note that the resin 125 includes the same material as resin 115.

Active-material uncoated area Q122 further has a first end portion E122a and a second end portion E122b. Second end portion E122b is located below the first end portion E122a. Partial area Q122a does not reach first end portion E121a. Similarly, partial area Q122a does not reach second end portion E121b.

Thus, the length of partial area Q122a in D3 direction is shorter than the length of metallic foil 121 in D3 direction. The length of partial area Q122a in D3 direction is shorter than the length (width) of second primary surface 1212 in D3 direction. The length of partial area Q122a in D3 direction is shorter than the length of active-material uncoated area Q122 in D3 direction. The length of partial area Q122a in D3 direction is shorter than the length of partial area Q121a of FIG. 3 in D3 direction.

In second primary surface 1212, only active-material uncoated area Q122, not including partial area Q122a, is exposed. Specifically, in second primary surface 1212, the U-shaped area of active-material uncoated area Q122, not including partial area Q122a, is exposed. Specifically, in FIG. 4, the left end portion of metallic foil 121 and portions of metallic foil 121 above and below the partial area Q122a are exposed.

FIG. 5 is a diagram showing negative electrode 110 as viewed in the orientation indicated by an arrow V of FIGS. 3 and 4. Note that, as with FIG. 3, etc., FIG. 5 shows the orientations and reference signs for parts of positive electrode 120 in parentheses to describe positive electrode 120 together.

As shown in FIG. 5, in negative electrode 110, first primary surface 1111 of metallic foil 111 has resin 113 disposed thereon and is coated with active material 112 (not shown). Second primary surface 1112 of metallic foil 111 has resin 115 disposed thereon and is coated with active material 114. As described above, second primary surface 1112 (specifically, active-material uncoated area Q112) of negative electrode 110 has first end portion E112a and second end portion E112b. First end portion E112a and second end portion E112b do not have resin 115 disposed thereon and are not coated with active material 114. At least first end portion E112a and second end portion E112b are exposed.

In positive electrode 120, first primary surface 1211 of metallic foil 121 has resin 123 disposed thereon and is coated with active material 122 (not shown). Second primary surface 1212 of metallic foil 121 has resin 125 disposed there on and is coated with active material 124. As described above, second primary surface 1212 (specifically, active-material uncoated area Q122) of positive electrode 120 has first end portion E122a and second end portion E122b. First end portion E122a and second end portion E122b do not have resin 125 disposed thereon and are not coated with active material 124. At least first end portion E122a and second end portion E122b are exposed.

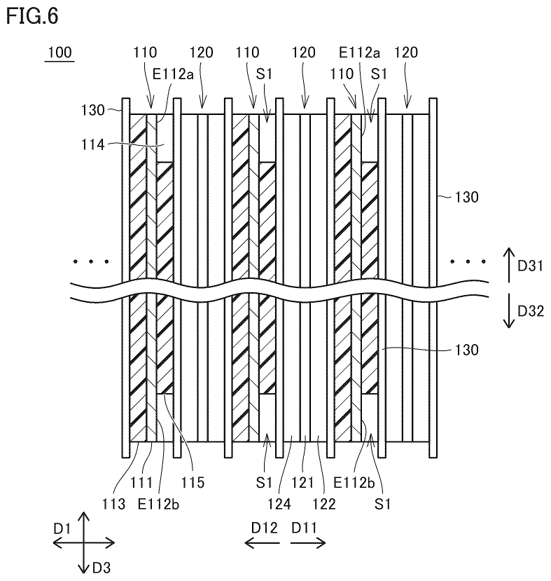

FIG. 6 is a cross-sectional arrow view of the stacked electrode assembly taken along a line VI-VI of FIG. 2. As shown in FIG. 6, in stacked electrode assembly 100, negative electrode 110 and positive electrode 120 are stacked in D1 direction with a separator 130 in-between.

Resin 113 disposed in partial area Q111a (FIG. 3) and resin 115 disposed in partial area Q112a (FIG. 4) are in contact with separator 130. Specifically, focusing on one negative electrode 110, resin 115 is in contact with a separator 130 adjacent to another separator 130 in contact with resin 113. Specifically, resin 115 is in contact with a separator 130 to the right (in the orientation of D11) of separator 130 that is in contact with resin 113.

Spaces S1 are formed between separator 130 and first and second end portions E112a and E112b, in D3 direction and on the partial area Q112a side, of active-material uncoated area Q112 (FIG. 4) of second primary surface 1112 of negative electrode 110. Specifically, space S1 is formed between first end portion E112a and separator 130 that is in contact with resin 115. Space S1 is formed between second end portion E112b and separator 130 in contact with resin 115. The two spaces S1 are formed between metallic foil 111 and separator 130 in contact with resin 115. These two spaces S1 are apart from each other in D3 direction. Space S1 is a gap.

The length of partial area Q112a (FIG. 4) in D3 direction is shorter than the length of metallic foil 111 in D3 direction. Specifically, the length of partial area Q112a in D3 direction is shorter than the length of active-material uncoated area Q112 in D3 direction. Therefore, spaces S1 are formed between metallic foil 111 and separator 130 in contact with resin 115. In this example, partial area Q112a is formed in the middle of active-material uncoated area Q112 in D3 direction. Therefore, the two spaces S1 are formed between metallic foil 111 and separator 130 in contact with resin 115.

Note that, in this example, the length of partial area Q111a (FIG. 3) in D3 direction is the same as the length of metallic foil 111 in D3 direction. Specifically, the length of partial area Q111a in D3 direction is the same as the length of active-material uncoated area Q111 in D3 direction. Therefore, no space S1 is formed between metallic foil 111 and separator 130 that is in contact with resin 113.

Spaces S1 formed between negative electrode 110 and separator 130 have been described above, with respect to FIG. 6. In stacked electrode assembly 100, positive electrode 120 has a configuration similar to negative electrode 110, as shown in FIGS. 3, 4, and 5. Accordingly, spaces (hereinafter, referred to as “spaces S2”) similar to spaces S1 are formed between positive electrode 120 and separator 130. Note that the spaces S2 are hidden from the view under the circumstances of FIG. 6, and, therefore, not shown.

Specifically, spaces S2 are formed between separator 130 and first and second end portions E122a and E122b, in D3 direction and on the partial area Q122a side, of active-material uncoated area Q122 (FIG. 4) of second primary surface 1212 of positive electrode 120. Specifically, space S2 is formed between first end portion E122a and separator 130 that is in contact with resin 125. Space S2 is formed between second end portion E122b and separator 130 in contact with resin 125. The two spaces S2 are formed between metallic foil 121 and separator 130 in contact with resin 125.

Note that the configuration of the positive electrode 120 side of negative electrode 110 is not limited to the above. Resin 123 of FIG. 3 may be disposed on the second primary surface 1212 side of FIG. 4 and resin 125 of FIG. 4 may be disposed on the first primary surface 1211 side of FIG. 3.

Note that the first primary surfaces 1111 and 1211 (FIG. 3) correspond to a “first surface” according to the present disclosure. Second primary surfaces 1112 and 1212 (FIG. 4) correspond to a “second surface” according to the present disclosure. Active-material coated areas P111, P112, P121, and P122 (FIGS. 3 and 4) correspond to an “active-material coated area” according to the present disclosure. Active-material uncoated areas Q111, Q112, Q121, and Q122 (FIGS. 3 and 4) correspond to an “active-material uncoated area” according to the present disclosure.

Specifically, active-material uncoated areas Q111 and Q121 (FIG. 3) correspond to an “active-material uncoated area of the first surface” according to the present disclosure. Active-material uncoated areas Q112 and Q122 (FIG. 4) correspond to an “active-material uncoated area of the second surface” according to the present disclosure.

Partial areas Q111a and Q121a (FIG. 3) correspond to a “second resin placement area” according to the present disclosure. Partial areas Q112a and Q122a (FIG. 4) correspond to a “first resin placement area” according to the present disclosure. The first end portions E112a and 122a (FIG. 4) and the second end portions E112b and 122b (FIG. 4) correspond to an “end portion of the active-material uncoated area of the second surface in the third direction” according to the present disclosure. The spaces S1 and S2 correspond to a “first space” according to the present disclosure.

Meanwhile, in the above, space S1 is formed of resin 115 (FIGS. 4 and 6) and space S2 is formed of resin 125 (FIG. 4). Specifically, as shown in FIG. 6, spaces S1 are formed between metallic foil 111 and separator 130 on the right side (the D11 side) of metallic foil 111. Similarly, spaces S2 (not shown) are formed between metallic foil 121 and separator 130 on the D12 side (see FIG. 5) of metallic foil 121.

Meanwhile, since the length of resin 113 (FIGS. 4 and 6) in D3 direction is the same as the length of metallic foil 111 in D3 direction, spaces like spaces S1 are not formed between metallic foil 111 and separator 130 on the left side (D12 side) of metallic foil 111, as shown in FIG. 6. Similarly, since the length of resin 123 (FIG. 4) in D3 direction is the same as the length of metallic foil 121 in D3 direction, spaces like spaces S2 are not formed between metallic foil 121 and separator 130 on the D11 side of metallic foil 121.

However, the present disclosure is not limited thereto. The shape and placement of resin 113 (FIG. 3) may be made the same as those of resin 115 (FIG. 4) to form spaces (hereinafter, “spaces S1”), similar to spaces S1, between metallic foil 111 and separator 130 on the D12 side (the left side in FIG. 6) of metallic foil 111. Similarly, the shape and placement of resin 123 (FIG. 3) may be made the same as those of resin 125 (FIG. 4) to form spaces (hereinafter, “spaces S2′”), similar to spaces S2, between metallic foil 121 and separator 130 on the D11 side of metallic foil 121.

More specifically, spaces S1′ may be formed between separator 130 and opposing ends, in D3 direction, of active-material uncoated area Q111 of first primary surface 1111 of negative electrode 110. Similarly, spaces S2′ may be formed between separator 130 and opposing ends, in D3 direction, of active-material uncoated area Q121 of first primary surface 1211 of positive electrode 120. As such, spaces may be formed between separator 130 and opposing ends, in D3 direction, of active-material uncoated areas Q111 and Q121 of first primary surfaces 1111 and 1211. Note that the spaces S1′ and S2′ correspond to a “second space.”

### <Summary>

(1) As shown in FIGS. 1 and 2, power storage module 1 includes stacked electrode assembly 100 and housing 2 in which the injection hole 2h for allowing an electrolyte solution to be impregnated into stacked electrode assembly 100 is formed, the housing 2 accommodating stacked electrode assembly 100. As shown in FIG. 2, stacked electrode assembly 100 includes each of electrodes (each negative electrode 110, each positive electrode 120) and each of separators 130 alternately stacked in D1 direction and extending in D2 direction perpendicular to D1 direction.

As shown in FIGS. 3, 4, and 5, each negative electrode 110 includes metallic foil 111 having first primary surface 1111 and second primary surface 1112 which is the backside of first primary surface 1111. Each positive electrode 120 includes metallic foil 121 having first primary surface 1211 and second primary surface 1212 which is the backside of first primary surface 1211.

As shown in FIG. 3, first primary surface 1111 of negative electrode 110 has active-material coated area P111 extending in D2 direction and coated with active material 112 and active-material uncoated area Q111 continuing to active-material coated area P111 in D2 direction and not coated with active material 112. Similarly, first primary surface 1211 of positive electrode 120 has active-material coated area P121 extending in D2 direction and coated with active material 112 and active-material uncoated area Q121 continuing to active-material coated area P121 in D2 direction and not coated with active material 122.

As shown in FIG. 4, second primary surface 1112 of negative electrode 110 has active-material coated area P112 extending in D2 direction and coated with active material 114 and active-material uncoated area Q112 continuing to active-material coated area P112 in D2 direction and not coated with active material 114. Similarly, second primary surface 1212 of positive electrode 120 has active-material coated area P122 extending in D2 direction and coated with active material 114 and active-material uncoated area Q122 continuing to active-material coated area P122 in D2 direction and not coated with active material 124.

As shown in FIGS. 3 and 4, active-material uncoated area Q112 of second primary surface 1112 of negative electrode 110 is located on the back of active-material uncoated area Q111 of first primary surface 1111 of metallic foil 111. Similarly, active-material uncoated area Q122 of second primary surface 1212 of positive electrode 120 is located on the back of active-material uncoated area Q121 of first primary surface 1211 of metallic foil 121.

As shown in FIG. 3, active-material uncoated area Q111 of first primary surface 1111 of negative electrode 110 has resin 113 disposed thereon and has partial area Q111a on the active-material coated area P111 side of first primary surface 1111. Similarly, active-material uncoated area Q121 of first primary surface 1211 of positive electrode 120 has resin 123 disposed thereon and has partial area Q121a on the active-material coated area P121 side of first primary surface 1211.

As shown in FIG. 4, active-material uncoated area Q112 of second primary surface 1112 of negative electrode 110 has resin 115 disposed thereon and partial area Q112a on the active-material coated area P112 side of second primary surface 1112. Similarly, active-material uncoated area Q122 of second primary surface 1212 of positive electrode 120 has resin 125 disposed thereon and partial area Q122a on the active-material coated area P122 side of second primary surface 1212.

As shown in FIG. 6, spaces S1 (the first spaces) are formed between separator 130 and first and second end portions E112a and E112b, in D3 direction perpendicular to D1 direction and D2 direction and on the partial area Q112a side, of active-material uncoated area Q112 of second primary surface 1112 of negative electrode 110. Similarly, spaces S2 (the first spaces, not shown) are formed between separator 130 and first and second end portions E122a and E122b, in D3 direction and on the partial area Q122a side, of active-material uncoated area Q122 of second primary surface 1212 of positive electrode 120.

With such a configuration, the electrolyte solution, injected in housing 2 through injection hole 2h, is allowed to be impregnated into stacked electrode assembly 100 through respective spaces S1 and S2. In other words, spaces S1 and S2 can be used as supply passages for the electrolyte solution. Accordingly, this obviates the need for a conduit in housing 2 for guiding the electrolyte solution. Therefore, stacked electrode assembly 100 has excellent electrolyte solution impregnation property and inhibits the reduction of the volumetric energy density in power storage module 1.

(2) As shown in FIG. 6, resin 115 disposed in partial area Q112a (FIG. 4) is in contact with separator 130 adjacent to separator 130 that is in contact with resin 113 disposed in partial area Q111a (FIG. 3). Resin 125 disposed in partial area Q122a (FIG. 4) is in contact with separator 130 adjacent to separator 130 that is in contact with resin 123 disposed in partial area Q121a (FIG. 3). As shown in FIGS. 4 and 6, the length of partial area Q112a in D3 direction is shorter than the length of metallic foil 111 in D3 direction. The length of partial area Q122a in D3 direction is shorter than the length of metallic foil 121 in D3 direction. With such a configuration, spaces S1 and S2 can be formed in stacked electrode assembly 100.

(3) As described above, spaces S1′ (the second spaces, not shown) may be formed between separator 130 and opposing ends (see E111a and E111b of FIG. 8), in D3 direction and on the partial area Q111a side, of active-material uncoated area Q111 of first primary surface 1111. Similarly, spaces S2′ (the second spaces, not shown) may be formed between separator 130 and opposing ends (see E121a and E121b of FIG. 8), in D3 direction and on the partial area Q121a side, of active-material uncoated area Q121 of first primary surface 1211. With such a configuration, spaces S1′ and S2′ can be additionally used as the supply passages for the electrolyte solution, in addition to spaces S1 and S2. Therefore, stacked electrode assembly 100 having such a configuration has excellent electrolyte solution impregnation property.

(4) As shown in FIG. 4, at opposing ends E112a and E112b, in D3 direction, of metallic foil 111, flow passages in D2 direction (in particular, the active-material coated area P112 side) for the electrolyte solution can be formed by resin 115. Similarly, at opposing ends E122a and E122b, in D3 direction, of metallic foil 121, flow passages in D2 direction (in particular, the active-material coated area P122 side) for the electrolyte solution can be formed by resin 125.

Furthermore, since resin 115 is provided on the active-material coated area P112 side, the flow passages in D3 direction for the electrolyte solution can be formed at end portions of metallic foil 111 on the D21 side. Similarly, since resin 125 is provided on the active-material coated area P122 side, the flow passages in D3 direction for the electrolyte solution can be formed at end portions of metallic foil 121 on the D22 side.

### <Variations>

A stacked electrode assembly 100A which is a variation of stacked electrode assembly 100 is now described.

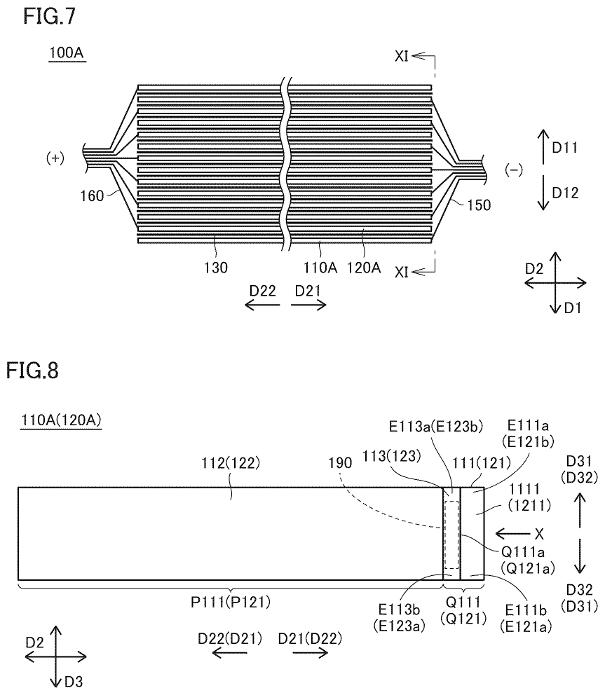

FIG. 7 is a diagram showing stacked electrode assembly 100A. As shown in FIG. 7, stacked electrode assembly 100A has multiple negative electrodes 110A, multiple positive electrodes 120A, and multiple separators 130. In stacked electrode assembly 100A, multiple electrodes (negative electrode 110A, positive electrode 120A) are alternately stacked in D1 direction with separator 130 in-between.

Stacked electrode assembly 100A further has multiple spacers 190 (FIGS. 8 to 11). Some of spacers 190 are inserted between negative electrodes 110A and separators 130. The remaining spacers 190 are inserted between positive electrodes 120A and separators 130. Each spacer 190 has one surface in contact with separator 130.

As such, stacked electrode assembly 100A differs from stacked electrode assembly 100 in that stacked electrode assembly 100A includes multiple spacers 190, while stacked electrode assembly 100 includes no spacer 190. Stacked electrode assembly 100A differs from stacked electrode assembly 100 in that stacked electrode assembly 100A has negative electrodes 110A, instead of negative electrodes 110. Stacked electrode assembly 100A differs from stacked electrode assembly 100 in that stacked electrode assembly 100A has positive electrodes 120A, instead of positive electrodes 120.

FIG. 8 is a diagram showing negative electrode 110A as viewed in the orientation of D11 of FIG. 7. Note that FIG. 8 shows the orientations and reference signs for parts of positive electrode 120A in parentheses for convenience of illustration to describe positive electrode 120A together.

As shown in FIG. 8, negative electrode 110A includes metallic foil 111. Metallic foil 111 has first primary surface 1111, as described above. The first primary surface 1111 side of negative electrode 110A has the same configuration as negative electrode 110 (FIG. 3). Similarly, positive electrode 120A includes metallic foil 121. Metallic foil 121 has first primary surface 1211, as described above. The first primary surface 1211 side of positive electrode 120A has the same configuration as positive electrode 120 (FIG. 3).

The length, in D3 direction, of partial area Q111a of negative electrode 110A is equal to the length of metallic foil 111 in D3 direction. In other words, the length of partial area Q111a in D3 direction is equal to the length of active-material uncoated area Q111 in D3 direction, as described above. Similarly, the length, in D3 direction, of partial area Q121a of positive electrode 120A is equal to the length of metallic foil 121 in D3 direction. In other words, the length of partial area Q121a in D3 direction is equal to the length of active-material uncoated area Q121 in D3 direction, as described above.

Active-material uncoated area Q111 of negative electrode 110A further has first end portion E111a and second end portion E111b. Second end portion E111b is located below the first end portion E111a. Similarly, active-material uncoated area Q121 of positive electrode 120A further has first end portion E121a and second end portion E121b. Second end portion E121b is located below the first end portion E121a.

Resin 113 of negative electrode 110A further has a first end portion E113a and a second end portion E113b. Second end portion E113b is located below the first end portion E113a. Similarly, resin 123 on positive electrode 120A further has a first end portion E123a and a second end portion E123b. Second end portion E123b is located below the first end portion E123a.

Some of spacers 190 are attached to resin 113. Spacer 190 has one surface in contact with resin 113 and the other surface in contact with separator 130. In this example, the length of spacer 190 in D3 direction is shorter than the length of resin 113 in D3 direction. The length of spacer 190 in D2 direction is shorter than the length of resin 113 in D2 direction. The present disclosure is not limited thereto and the length of spacer 190 in D2 direction may be the same as the length of resin 113 in D2 direction.

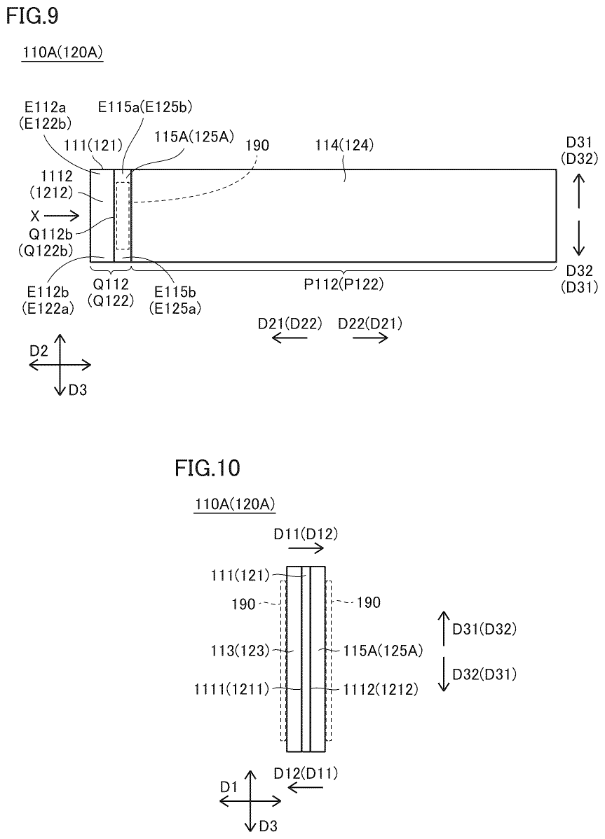

FIG. 9 is a diagram showing negative electrode 110A as viewed in the orientation of D12 of FIG. 7. Note that FIG. 9 shows the orientations and reference signs for parts of positive electrode 120A in parentheses for convenience of illustration to describe positive electrode 120A together.

As shown in FIG. 9, metallic foil 111 has second primary surface 1112, as described above. Second primary surface 1112 has active-material coated area P112 and active-material uncoated area Q112, as described above.

Active-material uncoated area Q112 has a partial area Q112b in which the resin 115A is disposed and which is located on the active-material coated area P112 side of second primary surface 1112. In this example, a partial area Q112b continues to active-material coated area P112. In second primary surface 1112, only active-material uncoated area Q112, not including partial area Q112b, is exposed. Specifically, in FIG. 9, the left end portion of metallic foil 111 is exposed.

As described above, active-material uncoated area Q112 further has first end portion E112a and second end portion E112b. Resin 115A further has a first end portion E115a and a second end portion E115b. Second end portion E115b is located below the first end portion E115a. Note that, in this example, resin 115A includes the same material as resin 115.

Some of spacers 190 are attached to resin 115A. Spacer 190 has one surface in contact with resin 115A and the other surface in contact with separator 130. In this example, the length, in D3 direction, of spacer 190 attached to resin 115A is shorter than the length of resin 115A in D3 direction. The length of spacer 190 in D2 direction is shorter than the length of resin 113 in D2 direction. The present disclosure is not limited thereto and the length of spacer 190 in D2 direction may be the same as the length of resin 113 in D2 direction.

Next, positive electrode 120A is described. Metallic foil 121 has second primary surface 1212, as described above. Second primary surface 1212 has active-material coated area P122 and active-material uncoated area Q122, as described above.

Active-material uncoated area Q122 has a partial area Q122b in which the resin 125A is disposed and which is located on the active-material coated area P122 side of second primary surface 1212. In this example, partial area Q122b continues to active-material coated area P122. In second primary surface 1212, only active-material uncoated area Q122, not including partial area Q122b, is exposed. In FIG. 9, the left end portion of metallic foil 121 is exposed.

As described above, active-material uncoated area Q122 further has first end portion E122a and second end portion E122b. Resin 125A further has a first end portion E125a and a second end portion E125b. Second end portion E125b is located below the first end portion E125a. Note that, in this example, resin 125A includes the same material as resin 115.

Some of spacers 190 are attached to resin 123. Spacer 190 has one surface in contact with resin 123 and the other surface in contact with separator 130. Some of spacers 190 are attached to resin 125A. Spacer 190 has one surface in contact with resin 125A and the other surface in contact with separator 130.

The length, in D3 direction, of the partial area Q112b of negative electrode 110A is equal to the length of metallic foil 111 in D3 direction. In other words, the length of the partial area Q112b in D3 direction is equal to the length of active-material uncoated area Q112 in D3 direction. Similarly, the length, in D3 direction, of partial area Q122b of positive electrode 120A is equal to the length of metallic foil 121 in D3 direction. In other words, the length of partial area Q122b in D3 direction is equal to the length of active-material uncoated area Q122 in D3 direction.

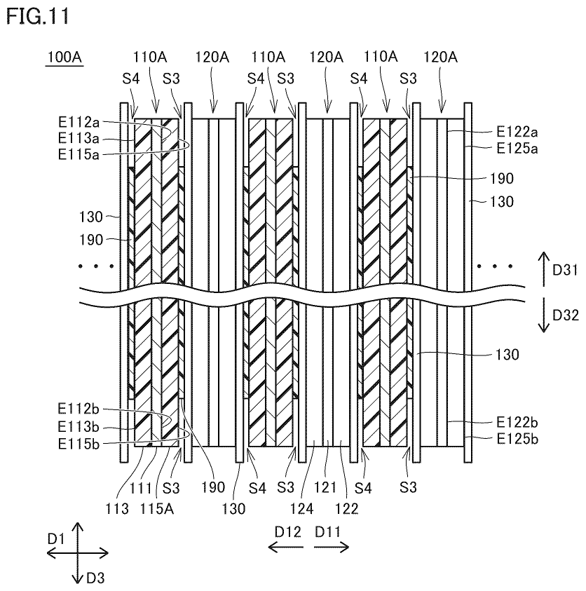

FIG. 10 is a diagram showing negative electrode 110A as viewed in the orientation indicated by an arrow X of FIGS. 8 and 9. Note that, as with FIG. 8, etc., FIG. 10 shows the orientations and reference signs for parts of positive electrode 120A in parentheses to describe positive electrode 120A together.

As shown in FIG. 10, in negative electrode 110A, first primary surface 1111 of metallic foil 111 has resin 113 disposed thereon and is coated with active material 112 (not shown). Second primary surface 1112 of metallic foil 111 is coated with resin 115A and active material 114 (not shown).

In positive electrode 120A, first primary surface 1211 of metallic foil 121 has resin 123 disposed there on and is coated with active material 122 (not shown). Second primary surface 1212 of metallic foil 121 has resin 125A disposed thereon and is coated with active material 124 (not shown).

FIG. 11 is a cross-sectional arrow view of stacked electrode assembly 100A taken along an XI-XI line of FIG. 7. As shown in FIG. 11, stacked electrode assembly 100A includes negative electrodes 110A and positive electrodes 120A stacked in D1 direction with separators 130 in-between.

Furthermore, stacked electrode assembly 100A includes spacers 190 disposed between negative electrodes 110A and separators 130, as described above.

Specifically, in this example, spacer 190 is disposed in first primary surface 1111 (see FIG. 8) and second primary surface 1112 (see FIG. 9) of negative electrode 110A. Similarly, spacer 190 is disposed between positive electrode 120A and separator 130. Specifically, spacer 190 is disposed in first primary surface 1211 and second primary surface 1212 of positive electrode 120A. Each spacer 190 is disposed in a middle portion of stacked electrode assembly 100A in D3 direction.

The length of spacer 190 in D3 direction is shorter than the length of negative electrode 110A in D3 direction. The length of spacer 190 in D3 direction is shorter than the length of positive electrode 120A in D3 direction. The length of spacer 190 in D3 direction is shorter than the lengths of metallic foils 111 and 121 in D3 direction. The length of spacer 190 in D3 direction is shorter than the length of each of active-material coated areas P111, P121, P112, and P122 in D3 direction. The length of spacer 190 in D3 direction is shorter than the length of each of active-material uncoated areas Q111, Q121, Q112, and Q122 in D3 direction.

Resin 113 disposed in partial area Q111a (FIG. 8) is in contact with separator 130. Resin 115A disposed in partial area Q112b (FIG. 9), in contrast, is not in contact with separator 130.

Spaces S3 are formed between separator 130 and first and second end portions E112a and E112b, in D3 direction and on the partial area Q112b side, of active-material uncoated area Q112 (FIG. 9) of second primary surface 1112 of negative electrode 110A. Specifically, spaces S3 are formed between first end portion E115a of resin 115A and separator 130 in contact with spacer 190. Similarly, spaces S3 are formed, on the partial area Q112b side, between second end portion E115b of resin 115A and separator 130 in contact with spacer 190. The two spaces S3 formed by one spacer 190 are apart from each other in D3 direction. Space S3 is a gap.

Since the length of spacer 190 in D3 direction is shorter than at least the length of negative electrode 110A in D3 direction, space S3 is formed. Since spacer 190 is disposed in a middle portion of stacked electrode assembly 100A in D3 direction, the two spaces S3 are formed in D3 direction by one spacer 190.

Spaces S4 are formed between separator 130 and the first and second end portions E111a and E111b, in D3 direction and on the partial area Q111a side, of active-material uncoated area Q111 (FIG. 8) of first primary surface 1111 of negative electrode 110A. Specifically, spaces S4 are formed between first end portion E113a of resin 113 and separator 130 in contact with spacer 190. Similarly, spaces S4 are formed, on the partial area Q111a side, between second end portion E113b of resin 113 and separator 130 in contact with spacer 190. Similarly to space S3, the two spaces S4 formed by one spacer 190 are apart from each other in D3 direction. Space S4 is a gap.

Since the length of spacer 190 in D3 direction is shorter than at least the length of negative electrode 110A in D3 direction, space S4 is formed. Since spacer 190 is disposed in a middle portion of stacked electrode assembly 100A in D3 direction, the two spaces S4 are formed in D3 direction by one spacer 190.

In stacked electrode assembly 100A, positive electrode 120A has a configuration similar to negative electrode 110A, as shown in FIGS. 8, 9, and 10. Furthermore, spacer 190 is disposed between positive electrode 120A and separator 130, as described above. Accordingly, spaces similar to spaces S3 and S4 are formed between positive electrode 120A and separator 130. Note that the spaces are hidden from the view FIG. 11, and, therefore, not shown.

Specifically, spaces (hereinafter, “spaces S3′” (not shown)), similar to spaces S3, are formed between separator 130 and first and second end portions E122a and E122b, in D3 direction and on the partial area Q122b side, of active-material uncoated area Q122 (FIG. 9) of second primary surface 1212 of positive electrode 120A. Specifically, space S3′ is formed between first end portion E125a of resin 125A and separator 130 that is in contact with spacer 190. Similarly, space S3′ is formed between second end portion E125b of resin 125 and separator 130 that is in contact with spacer 190.

Spaces (hereinafter, “spaces S4′” (not shown)), similar to spaces S4, are formed between separator 130 and the first and second end portions E121a and E121b, in D3 direction and on the partial area Q121a side, of active-material uncoated area Q121 (FIG. 8) of first primary surface 1211 of positive electrode 120A. Specifically, space S4′ is formed between the first end portion E123a of resin 123 and separator 130 that is in contact with spacer 190. Similarly, space S4′ is formed between the second end portion E123b of resin 123 and separator 130 that is in contact with spacer 190.

Note that first primary surfaces 1111 and 1211 (FIG. 8) correspond to the “first surface” according to the present disclosure. Second primary surfaces 1112 and 1212 (FIG. 9) correspond to the “second surface” according to the present disclosure. Active-material coated areas P111, P112, P121, and P122 (FIG. 8, FIG. 9) correspond to the “active-material coated area” according to the present disclosure. Active-material uncoated areas Q111, Q112, Q121, and Q122 (FIG. 8, FIG. 9) correspond to the “active-material uncoated area” according to the present disclosure.

Specifically, active-material uncoated areas Q111 and Q121 (FIG. 8) corresponds to the “active-material uncoated area of the first surface” according to the present disclosure. Active-material uncoated areas Q112 and Q122 (FIG. 9) correspond to the “active-material uncoated area of the second surface” according to the present disclosure.

Partial areas Q111a and Q121a (FIG. 8) correspond to the “second resin placement area” according to the present disclosure. Partial areas Q112b and Q122b (FIG. 9) correspond to the “first resin placement area” according to the present disclosure. First end portions E112a and 122a (FIG. 9) and second end portions E112b and 122b (FIG. 9) correspond to the “end portion of the active-material uncoated area of the second surface in the third direction” according to the present disclosure. First end portions E111a and 121a (FIG. 8) and second end portions E111b and 121b (FIG. 8) correspond to the “end portions, in the third direction, of the active-material uncoated area of the first surface” according to the present disclosure. Spaces S3 and S3′ correspond to the “first space” according to the present disclosure. Spaces S4 and S4′ correspond to the “second space” according to the present disclosure.

Stacked electrode assembly 100A is summarized as follows:

(1) As shown in FIG. 7, stacked electrode assembly 100A includes electrodes (each negative electrode 110A, each positive electrode 120A) and separators 130 alternately stacked in D1 direction and extending in D2 direction perpendicular to D1 direction.

As shown in FIGS. 8, 9, and 10, each negative electrode 110A includes metallic foil 111 having first primary surface 1111 and second primary surface 1112 which is the backside of first primary surface 1111. Each positive electrode 120A includes metallic foil 121 having first primary surface 1211 and second primary surface 1212 which is the backside of first primary surface 1211.

As shown in FIG. 8, first primary surface 1111 of negative electrode 110A has active-material coated area P111 extending in D2 direction and coated with active material 112 and active-material uncoated area Q111 continuing to active-material coated area P111 in D2 direction and not coated with active material 112. Similarly, first primary surface 1211 of positive electrode 120A has active-material coated area P121 extending in D2 direction and coated with active material 112 and active-material uncoated area Q121 continuing to active-material coated area P121 in D2 direction and not coated with active material 112.

As shown in FIG. 9, second primary surface 1112 of negative electrode 110A has active-material coated area P112 extending in D2 direction and coated with active material 114 and active-material uncoated area Q112 continuing to active-material coated area P112 in D2 direction and not coated with active material 114. Similarly, second primary surface 1212 of positive electrode 120A has active-material coated area P122 extending in D2 direction and coat ed with active material 114 and active-material uncoated area Q122 continuing to active-material coated area P122 in D2 direction and not coated with active material 114.

As shown in FIGS. 8 and 9, active-material uncoated area Q112 of second primary surface 1112 of negative electrode 110A is located on the back of active-material uncoated area Q111 of first primary surface 1111 of metallic foil 111. Similarly, active-material uncoated area Q122 of second primary surface 1212 of positive electrode 120A is located on the back of active-material uncoated area Q121 of first primary surface 1211 of metallic foil 121.

As shown in FIG. 8, active-material uncoated area Q111 of first primary surface 1111 of negative electrode 110A has resin 113 disposed thereon and has partial area Q111a on the active-material coated area P111 side of first primary surface 1111.

Similarly, active-material uncoated area Q121 of first primary surface 1211 of positive electrode 120A has resin 123 disposed thereon and has partial area Q121a on the active-material coated area P121 side of first primary surface 1211.

As shown in FIG. 9, active-material uncoated area Q112 of second primary surface 1112 of negative electrode 110A has resin 115A disposed thereon and has the partial area Q112b located on the active-material coated area P112 side of second primary surface 1112. Similarly, active-material uncoated area Q122 of second primary surface 1212 of positive electrode 120A has resin 125A disposed thereon and has partial area Q122b located on the active-material coated area P122 side of second primary surface 1212.

As shown in FIG. 11, spaces S3 are formed between separator 130 and first and second end portions E112a and E112b, in D3 direction perpendicular to D2 direction and D1 direction, of active-material uncoated area Q112 of second primary surface 1112 of negative electrode 110A. Specifically, spaces S3 are formed between separator 130 and the first and second end portions E115a and E115b, in D3 direction perpendicular to D1 direction and D2 direction, of resin 115A disposed in the partial area Q112b of negative electrode 110A.

Similarly, spaces S3′ are formed between separator 130 and first and second end portions E122a and E122b, in D3 direction, of active-material uncoated area Q122 of second primary surface 1212 of positive electrode 120A. Specifically, spaces S3′ are formed between separator 130 and the first and second end portions E125a and E125b, in D3 direction, of resin 125A disposed in partial area Q122b of positive electrode 120A.

With such a configuration, the electrolyte solution, injected in housing 2 through injection hole 2h, is allowed to be impregnated into stacked electrode assembly 100A through spaces S3 and S3′. In other words, spaces S3 and S3′ can be used as supply passages for the electrolyte solution. Accordingly, in this variation also, this obviates the need for a conduit in housing 2 for guiding the electrolyte solution. Therefore, stacked electrode assembly 100A has excellent electrolyte solution impregnation property and inhibits the reduction of the volumetric energy density in power storage module 1.

(2) Resin spacer 190 is further stacked between separator 130 and resin 115A disposed in partial area Q112b. With such a configuration, spaces S3 can be formed in stacked electrode assembly 100. Similarly, resin spacer 190 is further stacked between separator 130 and resin 125A disposed in partial area Q122b too. With such a configuration, spaces S3′ and be formed in stacked electrode assembly 100.

Resin spacer 190 is further stacked between separator 130 and resin 113 disposed in partial area Q111a. With such a configuration, spaces S4 can be formed in stacked electrode assembly 100. Similarly, resin spacer 190 is further stacked between separator 130 and resin 123 disposed in partial area Q121a. With such a configuration, spaces S4′ can be formed in stacked electrode assembly 100.

Note that, in the above, spaces S3 and S4 are formed by providing spacers 190 on both sides of negative electrode 110A, as shown in FIG. 10. However, the present disclosure is not limited thereto. Spacer 190 may be provided only on one side of negative electrode 110A. In this case, either one of spaces S3 and S4 is formed. Similarly, spacer 190 may be provided only on one side of positive electrode 120A. In this case, one of spaces S3′ and S4′ is formed.

While the embodiment according to the present disclosure has been described above, the presently disclosed embodiments should be considered in all aspects illustrative and not restrictive. The scope of the present disclosure is defined by the appended claims. All changes which come within the meaning and range of equivalency of the appended claims are to be embraced within their scope.

What is claimed is:

1. A stacked electrode assembly, comprising:
a plurality of electrodes; and
a plurality of separators, wherein
each of the electrodes and each of the separators are alternately stacked in a first direction,
the stacked electrode assembly extends in a second direction perpendicular to the first direction,
the electrode includes a metallic foil having a first surface and a second surface which is a backside of the first surface,
the first surface and the second surface each have an active-material coated area extending in the second direction and coated with an active material and an active-material uncoated area continuing to the active-material coated area in the second direction and not coated with the active material,
the active-material uncoated area of the second surface:
is located on back of the active-material uncoated area of the first surface of the metallic foil; and
has a first resin placement area in which a resin is disposed and which is located on an active-material coated area side of the second surface, wherein
a first space is formed between the separator and an end portion, in a third direction perpendicular to the first direction and the second direction and on a first resin placement area side, of the active-material uncoated area of the second surface.

2. The stacked electrode assembly according to claim 1, wherein
the resin is in contact with the separator, and
a length of the first resin placement area in the third direction is shorter than a length of the metallic foil in the third direction.

3. The stacked electrode assembly according to claim 1, wherein
a resin spacer is disposed between the resin and the separator.

4. The stacked electrode assembly according to claim 1, wherein
the active-material uncoated area of the first surface has a second resin placement area in which a resin is disposed and which is located on an active-material coated area side of the first surface, and
a second space is formed between the separator and an end portion, in the third direction and on a second resin placement area side, of the active-material uncoated area of the first surface.

5. A power storage module, comprising:
the stacked electrode assembly according to claim 1; and
a housing accommodating the stacked electrode assembly.
